(19) United States
(12) Patent Application Publication
(10) Pub. No.: US 2013/0311408 A1
(43) Pub. Date: Nov. 21, 2013

(54) Determining and Predicting Popularity of Content

(71) Applicant: Comcast Cable Communications, LLC, Philadelphia, PA (US)

(72) Inventors: Amit Bagga, Basking Ridge, NJ (US); Jan Neumann, Arlington, VA (US); Xiaodong Yu, College Park, MD (US); Scot Zola, Scottsdale, AZ (US)

(73) Assignee: Comcast Cable Communications, LLC, Philadelphia, PA (US)

(21) Appl. No.: 13/894,929

(22) Filed: May 15, 2013

Related U.S. Application Data
(60) Provisional application No. 61/647,062, filed on May 15, 2012.

(51) Int. Cl. G06N 99/00

(52) U.S. Cl. CPC G06N 99/005
USPC 706/12; 706/21

(57) ABSTRACT

Processes and systems are described herein that may be used to predict which content (e.g., programs, series, movies, channels etc.) will be popular in the future. The processes and systems may use a model that is trained using historical data reflecting information about past showings of programs, such as rating information, viewer behaviors (e.g., channel changes and DVR recordings), online social activity (e.g., Facebook likes and relevant Twitter messages), and/or other data. Accordingly, it may be possible to provide predictive recommendations of popular content before, for example, the content is scheduled or otherwise planned to be distributed or made available to viewers. The results of such prediction may be integrated with, for example, a program guide available to viewers.

### CROSS-REFERENCE TO RELATED CASES

The present non-provisional application claims priority to U.S. Provisional Patent Application Ser. No. 61/647,062, entitled “Program Popularity Systems and Methods,” filed May 15, 2012, the entire contents of which is hereby incorporated by reference.

### BACKGROUND

The question of “what's on TV?” is part of the daily ritual of watching video content. A viewer may start by examining a program guide and/or surf from channel to channel to find out what programs are playing on what channel. The order of the channels in the program guide may rarely change, and though the order may or may not be based on thematic groupings, the program guide may not necessarily reflect that the themes and popularity of various channels and programs changes over the course of a week or even a day.

Data collection and market research often use third party companies to collect and sell information about viewer's television watching habits and the general popularity of television programs. Additional sources of behavioral data are available including what users search for on a website, the movies they choose to record on their home digital video recorder (DVR), and what channels are tuned to. While useful to media companies and advertisers in a variety of areas, access to and analysis of such data is generally delayed. As a result, collection, processing, and distribution lag times mean that such collected information may be merely historical. These and other shortcomings are addressed in this disclosure.

### SUMMARY

The following summary is for illustrative purposes only, and is not intended to limit or constrain the detailed description.

Processes and systems are described herein that may be used to predict which future content (e.g., programs, series, movies, channels etc.) will be popular in the future. The processes and systems may use a model that is trained using historical data reflecting information about past showings, viewings, and/or other use of programs, such as, for example, Nielsen or other rating information, viewer behaviors (e.g., channel changes and DVR recordings), online social activity (e.g., Facebook likes and relevant Twitter messages), and/or other data. Accordingly, it may be possible to provide recommendations of predicted popular content before the content is scheduled or otherwise planned to be distributed to viewers. The results of such prediction may be integrated with, for example, a program guide available to viewers.

The processes and systems may be used to predict the popularity of any item of video and/or audio content, such as but not limited to television programs, online videos, scheduled content, on-demand content, movie theater showings, radio content, etc. For example, by taking in to account the popularity of actors, themes and genres across calendar time, the model may be used to predict the popularity and/or total box office response of movies that have not yet been released in movie theaters and/or on DVD.

The popularity of an item of content may be used as a signal into and/or a data point for a number of useful features. For example, the predicted popularity of an item of content may be correlated with the impact of an advertisement played in conjunction with the content and/or with click through rates for on-line programming. Therefore, predicted popularity of an item of content may be correlated with past correlations between popularity and advertising impact to predict upcoming advertising impact rates. This may be useful, for example, in determining an appropriate amount to be charged by the content distributor for an advertisement time slot. Moreover, since the popularity of an item of content may be predicted on a real-time or near real-time basis (e.g., during the transmission of the item of content), a content distributor may dynamically adjust the advertising rate for an advertisement time slot, even during the showing of the item of content that is associated with the advertisement time slot. Alerts may also be provided to viewers in real time or near-real time, indicating (such as via a user interface at a viewer's device) that there is strong social activity (e.g., many Facebook “likes” and/or Twitter mentions) related to a particular item of content. In addition, items of content predicted to be popular (e.g., meeting at least a minimum predicted popularity rating value) may be automatically recorded by a viewer's DVR. Moreover, predicted popularity of items of content may be used as a signal for personalized recommendations of content to viewers. For example, predicted popularity may be used in lieu of, or in conjunction with, actual usage data as a signal for computing personalized recommendations.

Accordingly, some features herein relate to, for example, using data associated with past showings, viewings, or other use of items of content to predict a ranking of an available (e.g., currently available, future and/or scheduled) item of content. Data based on the ranking of the future item of content may be sent over a network to a device.

Additional features relate to, for example, determining a plurality of future items of content scheduled to be shown during a future time period, and using data representing popularity of past use of items of content to predict popularity of each of the plurality of future items of content. Data representing the popularity of at least one of the plurality of future items of content may be sent over a network to a device.

Still further features may relate to, for example, using data representing popularity of past use of items of content to predict popularity of each of a plurality of future items of content, and generating a user interface comprising an indication of the popularity of at least one of the plurality of future items of content.

The summary here is not an exhaustive listing of the novel features described herein, and are not limiting of the claims. These and other features are described in greater detail below.

### BRIEF DESCRIPTION OF THE DRAWINGS

These and other features, aspects, and advantages of the present disclosure will become better understood with regard to the following description, claims, and drawings. The present disclosure is illustrated by way of example, and not limited by, the accompanying figures in which like numerals indicate similar elements.

FIG. 1 illustrates an example communication network on which various features described herein may be implemented.

FIG. 2 illustrates an example computing device that can be used to implement any of the methods, servers, entities, and computing devices described herein.

FIG. 3 is a flow chart of an example method that may be performed in accordance with one or more aspects as described herein.

FIGS. 4A-4D show example user interfaces that may be presented in accordance with one or more aspects as described herein.

FIG. 5 is a table of example data that may be used in accordance with one or more aspects as described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

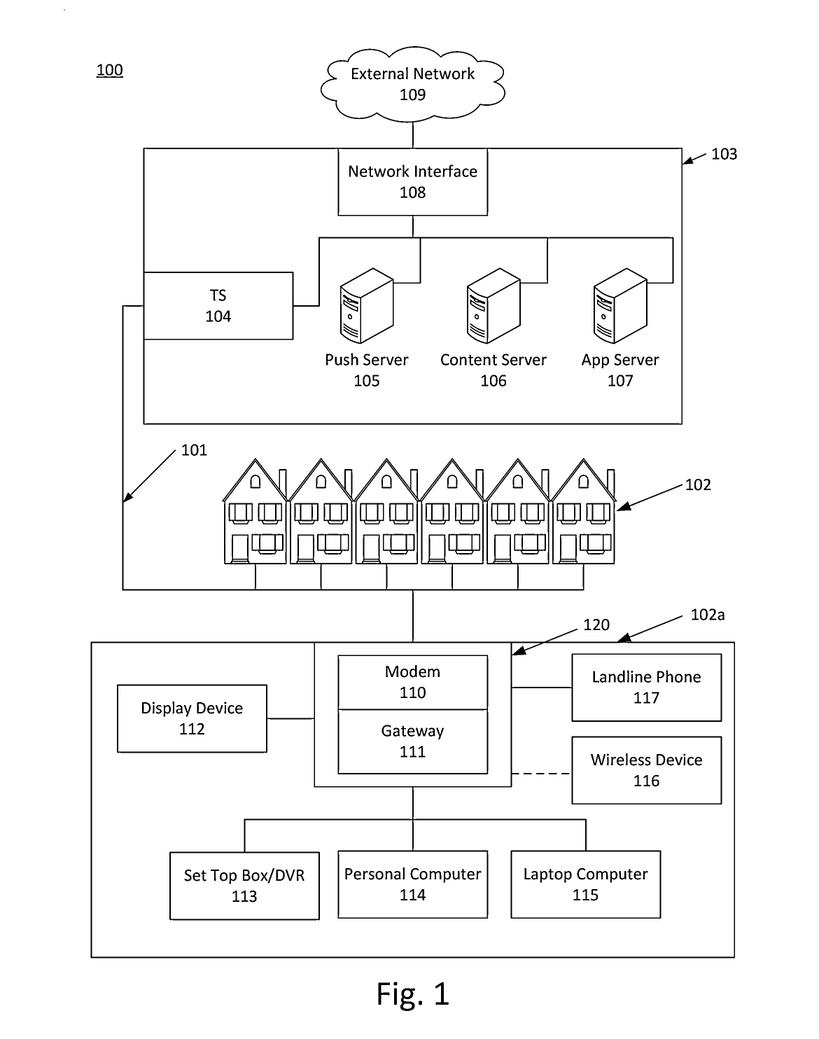

FIG. 1 illustrates an example communication network 100 on which many of the various features described herein may be implemented. Network 100 may be any type of information distribution network, such as satellite, telephone, cellular, wireless, etc. One example may be an optical fiber network, a coaxial cable network, or a hybrid fiber/coax distribution network. Such networks 100 use a series of interconnected communication links 101 (e.g., coaxial cables, optical fibers, wireless, etc.) to connect multiple premises 102 (e.g., businesses, homes, consumer dwellings, etc.) to a local office (e.g., headend) 103. The local office 103 may transmit downstream information signals onto the links 101, and each premises 102 may have a receiver used to receive and process those signals.

There may be one link 101 originating from the local office 103, and it may be split a number of times to distribute the signal to various premises 102 in the vicinity (which may be many miles) of the local office 103. The links 101 may include components not illustrated, such as splitters, filters, amplifiers, etc. to help convey the signal clearly, but in general each split introduces a bit of signal degradation. Portions of the links 101 may also be implemented with fiber-optic cable, while other portions may be implemented with coaxial cable, other lines, or wireless communication paths. By running fiber optic cable along some portions, for example, signal degradation may be significantly minimized, allowing a single local office 103 to reach even farther with its network of links 101 than before.

The local office 103 may include an interface, such as a termination system (TS) 104. More specifically, the interface 104 may be a cable modem termination system (CMTS), which may be a computing device configured to manage communications between devices on the network of links 101 and backend devices such as servers 105-107 (to be discussed further below). The interface 104 may be as specified in a standard, such as the Data Over Cable Service Interface Specification (DOCSIS) standard, published by Cable Television Laboratories, Inc. (a.k.a. CableLabs), or it may be a similar or modified device instead. The interface 104 may be configured to place data on one or more downstream frequencies to be received by modems at the various premises 102, and to receive upstream communications from those modems on one or more upstream frequencies.

The local office 103 may also include one or more network interfaces 108, which can permit the local office 103 to communicate with various other external networks 109. These networks 109 may include, for example, networks of Internet devices, telephone networks, cellular telephone networks, fiber optic networks, local wireless networks (e.g., WiMAX), satellite networks, and any other desired network, and the network interface 108 may include the corresponding circuitry needed to communicate on the external networks 109, and to other devices on the network such as a cellular telephone network and its corresponding cell phones.

As noted above, the local office 103 may include a variety of servers 105-107 that may be configured to perform various functions. For example, the local office 103 may include a push notification server 105. The push notification server 105 may generate push notifications to deliver data and/or commands to the various premises 102 in the network (or more specifically, to the devices in the premises 102 that are configured to detect such notifications). The local office 103 may also include a content server 106. The content server 106 may be one or more computing devices that are configured to provide content to users at their premises. This content may be, for example, video on demand movies, television programs, songs, text listings, etc. The content server 106 may include software to validate user identities and entitlements, to locate and retrieve requested content, to encrypt the content, and to initiate delivery (e.g., streaming) of the content to the requesting user(s) and/or device(s).

The local office 103 may also include one or more application servers 107. An application server 107 may be a computing device configured to offer any desired service, and may run various languages and operating systems (e.g., servlets and JSP pages running on Tomcat/MySQL, OSX, BSD, Ubuntu, Redhat, HTML5, JavaScript, AJAX and COMET). For example, an application server may be responsible for collecting television program listings information and generating a data download for electronic program guide listings. Another application server may be responsible for monitoring user viewing habits and collecting that information for use in selecting advertisements. Yet another application server may be responsible for formatting and inserting advertisements in a video stream being transmitted to the premises 102. Although shown separately, one of ordinary skill in the art will appreciate that the push server 105, content server 106, and application server 107 may be combined. Further, here the push server 105, content server 106, and application server 107 are shown generally, and it will be understood that they may each contain memory storing computer executable instructions to cause a processor to perform steps described herein and/or memory for storing data.

An example premises 102a, such as a home, may include an interface 120. The interface 120 can include any communication circuitry needed to allow a device to communicate on one or more links 101 with other devices in the network. For example, the interface 120 may include a modem 110, which may include transmitters and receivers used to communicate on the links 101 and with the local office 103. The modem 110 may be, for example, a coaxial cable modem (for coaxial cable lines 101), a fiber interface node (for fiber optic lines 101), twisted-pair telephone modem, cellular telephone transceiver, satellite transceiver, local wi-fi router or access point, or any other desired modem device. Also, although only one modem is shown in FIG. 1, a plurality of modems operating in parallel may be implemented within the interface 120. Further, the interface 120 may include a gateway interface device 111. The modem 110 may be connected to, or be a part of, the gateway interface device 111. The gateway interface device 111 may be a computing device that communicates with the modem(s) 110 to allow one or more other devices in the premises 102a, to communicate with the local office 103 and other devices beyond the local office 103. The gateway 111 may be a set-top box (STB), digital video recorder (DVR), computer server, or any other desired computing device. The gateway 111 may also include (not shown) local network interfaces to provide communication signals to requesting entities/devices in the premises 102a, such as display devices 112 (e.g., televisions), additional STBs or DVRs 113, personal computers 114, laptop computers 115, wireless devices 116 (e.g., wireless routers, wireless laptops, notebooks, tablets and netbooks, cordless phones (e.g., Digital Enhanced Cordless Telephone—DECT phones), mobile phones, mobile televisions, personal digital assistants (PDA), etc.), landline phones 117 (e.g. Voice over Internet Protocol—VoIP phones), and any other desired devices. Examples of the local network interfaces include Multimedia Over Coax Alliance (MoCA) interfaces, Ethernet interfaces, universal serial bus (USB) interfaces, wireless interfaces (e.g., IEEE 802.11, IEEE 802.15), analog twisted pair interfaces, Bluetooth interfaces, and others.

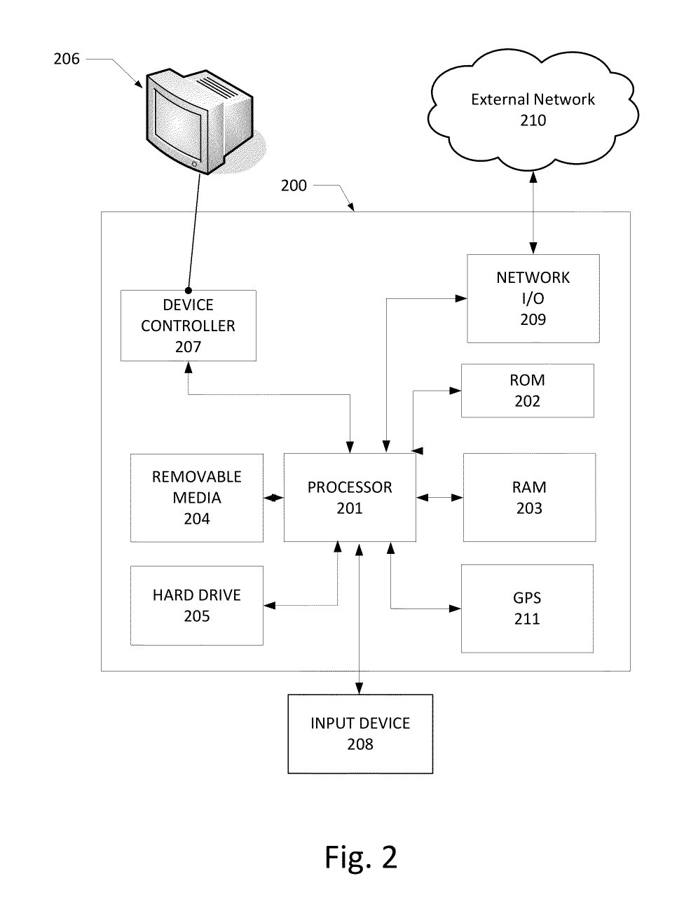

FIG. 2 illustrates general hardware elements that can be used to implement any of the various computing devices discussed herein. The computing device 200 may include one or more processors 201, which may execute instructions of a computer program to perform any of the features described herein. The instructions may be stored in any type of computer-readable medium or memory, to configure the operation of the processor 201. For example, instructions may be stored in a read-only memory (ROM) 202, random access memory (RAM) 203, removable media 204, such as a Universal Serial Bus (USB) drive, compact disk (CD) or digital versatile disk (DVD), floppy disk drive, or any other desired storage medium. Instructions may also be stored in an attached (or internal) hard drive 205. The computing device 200 may include one or more output devices, such as a display 206 (e.g., an external television), and may include one or more output device controllers 207, such as a video processor. There may also be one or more user input devices 208, such as a remote control, keyboard, mouse, touch screen, microphone, etc. The computing device 200 may also include one or more network interfaces, such as a network input/output (I/O) circuit 209 (e.g., a network card) to communicate with an external network 210. The network input/output circuit 209 may be a wired interface, wireless interface, or a combination of the two. In some embodiments, the network input/output circuit 209 may include a modem (e.g., a cable modem), and the external network 210 may include the communication links 101 discussed above, the external network 109, an in-home network, a provider's wireless, coaxial, fiber, or hybrid fiber/coaxial distribution system (e.g., a DOCSIS network), or any other desired network. Additionally, the device may include a location-detecting device, such as a global positioning system (GPS) microprocessor 211, which can be configured to receive and process global positioning signals and determine, with possible assistance from an external server and antenna, a geographic position of the device.

The FIG. 2 example is a hardware configuration, although the illustrated components may be implemented as software as well. Modifications may be made to add, remove, combine, divide, etc. components of the computing device 200 as desired. Additionally, the components illustrated may be implemented using basic computing devices and components, and the same components (e.g., processor 201, ROM storage 202, display 206, etc.) may be used to implement any of the other computing devices and components described herein. For example, the various components herein may be implemented using computing devices having components such as a processor executing computer-executable instructions stored on a computer-readable medium, as illustrated in FIG. 2. Some or all of the entities described herein may be software based, and may co-exist in a common physical platform (e.g., a requesting entity can be a separate software process and program from a dependent entity, both of which may be executed as software on a common computing device).

One or more aspects of the disclosure may be embodied in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects of the disclosure, and such data structures are contemplated within the scope of computer executable instructions and computer-usable data described herein.

As discussed above, the popularity of content scheduled to be broadcast, streamed, or otherwise provided (e.g., distributed over a network such as the communications links 101, or in a movie theater) at a future time may be predicted, such as in the next 24 hours, in the next 72 hours, or in the next 24 to 72 hours). The results of the prediction may be presented to content viewers, such as in a form that is part of an electronic program guide. For instance, the information presented to viewers may include an indication of the predicted popularity of one or more items of current and/or future (e.g., scheduled) content. Such information may potentially allow a service provider to provide viewers with an improved user experience.

Currently, the most prominent metric to measure the popularity of television programs and the channels on which television programs are distributed is provided by Nielsen Media. Nielson publishes, for example, the well-known suite of Nielsen TV ratings. One of the ratings, for example, indicates the percentage of polled viewers that are currently tuned to a particular television program. During the last couple of years, however, the consumption patterns of viewers have been undergoing a rapid change in which program content is consumed on a range of devices other than conventional television sets, such as cellular phones, personal computers, and tablet computers. Also, viewers now tend to interact through the Internet socially about content via Twitter, Facebook, and other social networking web sites. As will be discussed further below, such social network activity may be utilized to further gauge the engagement of the viewers with items of content. On some social networking web sites, viewers of content may indicate their level of like (or dislike) for the content by, e.g., publishing messages and/or explicit symbolic feedback related to the content and/or features of the program such as actors, and viewers may also indicate in real time that they are currently watching a given item of content (e.g. via Zeebox, GetGlue, IntoNow, or Shazam).

Information about past use (e.g., showings, such as broadcasts, unicasts, multicasts, and/or other types of transmission, or viewings) of items of content, such as Nielsen ratings, social network activity, scheduled DVR recordings by viewers (e.g., using devices such as set top box/DVR 113), and/or other behaviors relating to viewing and/or not viewing particular items of content (e.g., tuning to content or away from content, how long content is tuned to, etc.), may be used to build a model, through machine learning techniques, that may combine such historical information to predict the popularity of one or more items of content that are currently being shown and/or of one or more items of content that are scheduled or otherwise expected to be shown in the future. Each of these example sources of historical and/or current information may capture a different notion of popularity of various items of content and/or channels or other services on which the items of content are organized and provided.

Nielsen ratings, for example, have long been used by content providers to measure the audience participation of television programs. The Nielsen shares, which indicate, over time, the percentage of viewers that are tuned to a given channel or television program compared to all viewers that use their television at the moment, have typically been used to judge the success of a previously-shown television program and to set the rates for advertisers. Due to the nature of the data collection, however, Nielsen audience measurements are available only after a certain amount of delay. Moreover, at least some of the delay may be due to the inclusion in the viewing numbers of the delayed consumption of programs recorded to DVR and watched at a later time.

Channel ratings have typically been determined by monitoring the television consumption behavior of a small sample population of households and then extrapolating these sample statistics to the universe of all television consumers. A channel score may be determined for each channel at a given time interval using such ratings information for that channel (such as from Nielsen, another source, and/or internally generated information). For example, the channel score for a given channel (or other type of service) and for a given time interval of a given day may be based on the average, mean, or other evaluation of the number of viewers tuned to the given channel within the time interval. For instance, the average or mean number of viewers tuned to the given channel may be determined for each fifteen-minute interval, each half-hour interval, each hour interval, or for any other intervals. It is noted that not all types of content are necessarily provided on channels, and not all types of distribution networks necessarily utilize multiple viewer-selectable channels. In that case, it may not make sense to utilize a channel score.

Similarly, a content score may be determined for a given item of content at a given time interval using, for example, ratings information for that item of content (such as from Nielsen, another source, and/or internally generated information). For example, the content score for a given item of content for a given time interval may be based on the average, mean, or other evaluation of the number of viewers tuned to or otherwise viewing the given item of content, recording the given item of content, and/or that have a recording scheduled (such as using a DVR) for the given item of content. The content score may be a score for each item of content at a given time interval, or for each item of content regardless of time intervals, as desired.

The historical (past) channel and/or content scores, which again may be organized by fixed and/or predetermined time intervals if desired, may be used at least in part to make predictions as to future viewer activity associated with various channels and/or items of content. In other words, historical information about channel and/or content viewership may be used to predict future channel and/or content viewership. Before using such collected channel and/or content viewership information to make predictions, one or more pre-processing steps may be performed. For example, since a Nielsen channel or viewing source may correspond to a number of related channels as used by viewers (e.g. all NBC broadcast channels may be aggregated in a single “NBC Nielsen channel”, all HBO-East, HBO-West and SD//HD channels may map to a single “Nielsen HBO channel,” etc.), a mapping may be created between the physical stations and the Nielsen aggregate channels. More generally, where the source channel ratings information is for groups of channels, the source ratings information may be mapped to individual channels within the groups. For example, if the source channel ratings information is provided for both a first plurality of channels and a second plurality of channels, then each of the channels in the first plurality may be associated with the channel ratings information for the first plurality, and each of the channels in the second plurality may be associated with the channel ratings information for the second plurality.

Also, where the ratings data source (such as ratings data from Nielsen) does not use unique IDs to identify programs, it may be desirable to match a given item of content in the schedule to the corresponding item of content in the ratings data source. This may be implemented using, for instance, a combination of editorially-created regular expression matching together with natural language-based distance metrics. After establishing correspondence, the ratings for a given item of content may be found for earlier instances of the item of content (e.g., earlier episodes in a television program series or other series of content). For example, the earlier instances may initially be expected to be found at the same timeslot and day of week for a given number of preceding weeks. The same process may be repeated for channel popularity.

The data for historical ratings (channel and/or content ratings) used to make a prediction may be collected for a predetermined past window of time. The past window of time may be, for example, the preceding six months, or the preceding three months, or a time period of a length between the preceding three months and the preceding six months. These are merely a limited number of examples; the past window of time may be of any length and may span any beginning and ending points. Moreover, the past window of time may be dynamic, such as in the form of a moving window that has beginning and/or end points at days and/or times that depend upon the current day and/or time. In further examples, the historical data used for prediction may be, not for a predetermined and/or fixed window of time, but rather for a particular (e.g., predetermined and/or predetermined minimum) number of data points. For example, the historical data timeframe for a given item of content may be such that there are a particular number of ratings for previous episodes or other instances of the item of content (e.g., the past seven instances of the item of content).

Using past ratings information to predict popularity of items of content that were never previously distributed to viewers or that have not recently or frequently been distributed may be challenging, because there may not be as many samples available to make an accurate prediction. Examples of such items of content may include yearly awards shows such as the Oscar's, Emmy's, Grammy's, large sporting events like the Olympics, NFL or NBA playoffs, news breaks, and newly scheduled programs. To deal with such an item of content, DVR scheduling statistics may be utilized to count how many viewers have scheduled their DVR to record the item of content. This count may be used to generate a DVR score. The DVR score may be computed by, for example, aggregating the number of scheduled recordings for specific episodes of a series of content, and/or for the series itself, across the set of viewers. While doing so, it may be desirable to account for differences in the number of users across different markets (e.g., across different geographical regions), so that the DVR score may be normalized.

In addition to or instead of any of the above mentioned scores, a social activity score may be determined for each given item of content and/or for each given channel, at each given time interval. As previously mentioned, there are various types of information that may be gathered from social networking web services and used to generate the social activity score. Examples of such information may include connections and/or activities occurring between different participants in a social network (e.g. friends, followers), and/or the activity between participants in such networks.

According to a recent Nielsen/SocialGuide study, there is generally a strong correlation between the Twitter activity related to television programs, as measured by tweets containing the hash tags associated with it, and ratings for television programs. The study found that, for young adults (14-34 years old), an 8.5% increase in Twitter activity correlated with a 1% increase in television program ratings for premiere episodes, and a 4.2% increase in Twitter activity correlated with a 1% increase in ratings for mid-season episodes. For older viewers, this effect was weaker but still present (a 3.5% increase in Twitter activity correlated with a 1% increase in television program ratings).

Moreover, information about viewer participation in social web services is often made available to third parties via application programming interfaces (APIs). Such information may be used to monitor social network interactions related to program content in real time or near-real time. For example, when someone tweets a message related to an item of content, Twitter may make the message instantly available on its message feed (which may be publicly available), and such messages may be collected, analyzed, and filtered to produce aggregate information available in real-time, such as aggregate counts of Twitter and Facebook activity. For example, messages may be monitored and searched (filtered) for the names of items of content, for actors, for directors, for channel names, etc. The messages found to have such content may be correlated to the appropriate items of content and/or channels. Thus, for a given program, for example, aggregate counts of monitored Twitter and Facebook activity may be generated for a time period surrounding the timeframe that the program was delivered (e.g., broadcast). The timeframe may be, for instance, +/−3 hours, or +/−1 hour, or any other time period that includes time before and/or after the scheduled delivery time of the item of content. As with the DVR score, the social activity score may be normalized with respect to the number of participants in each of various geographical regions from which the data is collected.

Other information that may be used by the model to predict popularity may include, for example, query logs. For instance, viewers and other users may use the Internet to search for particular items of content, particular actors, particular directors, and the like. If the search query information is made available (such as via searches made on a web site of the content provider or another web site), then such searches may provide clues as to what is popular at the moment.

Still other information that may be used by the model to predict popularity may include, for example, remote DVR commands. Some content providers, such as Comcast, allow users to send commands to control their DVR devices remotely over a network such as the Internet and/or a cellular telephone network. A server (such as the application server 107) may receive the commands and, in turn, transmit commands to the appropriate DVR devices (such as an EBIF command). These commands may be captured and logged to indicate which items of content are being set for recordings, and may be used as part of the DVR score. This may be expanded to utilize all DVR data and other viewer device data including analyzing the items of content that viewers watch using their DVRs, the percentages/portions of the items of content that are watched, data about which items of content are tuned to and on which channels, whether the items of content being watched are linear scheduled television programs or video-on-demand items of content, the time spent viewing particular items of content, the percentages/portions of the items of content through which the viewers fast forward or otherwise skip, the number of times that a particular item of recorded content has been watched using the same DVR, how many viewers set a DVR to record an item of content, how many viewers watched this program over a certain time period such as the course of the last month, and/or how many viewers actually changed the channel on their device in order to watch items of content during a certain time period such as during the last week. Any of this information may be relevant to, and used by the model to predict, popularity of various items of content.

Any of the scores and/or other information may be used (e.g., combined) by the model to predict, for a given item of content, a given channel, and/or a given time interval, a popularity of the item of content and/or channel. For example, any of the channel score, the content score, the DVR score, and/or the social activity score may be used together to determine a predicted popularity (e.g., a popularity score) of the item of content and/or channel. As will be described further below, a software model may be trained and used to make such predictions.

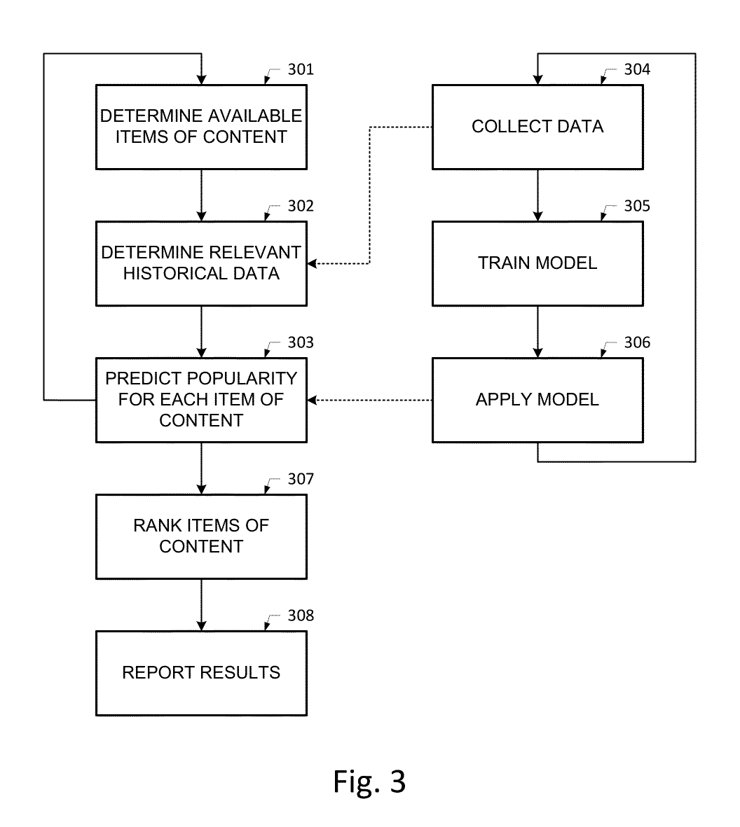

FIG. 3 is a flowchart of an example method that may be performed in accordance with one or more aspects as described herein, and that may be performed by one or more elements of, for example, the system of FIGS. 1 and/or 2. The method may be used for making predictions of the popularity of current and/or future (e.g., scheduled) items of content. While certain steps may be described below as being performed by a specific element, it will be understood that this is merely an example, and that each step may be performed by alternative elements. Moreover, while the steps are shown in a particular order and divided into specific steps, it will be understood that the order may be modified, and that one or more of the steps may be combined and that one or more of the steps may be further sub-divided into further steps.

The method of FIG. 3 shows at least two processes that may operate individually, or partially or fully in parallel, if desired. In one of the processes (steps 304-306), a model may be trained based on collected data. In the other of the processes (steps 301-303, 307, and 308), the model may be applied to make predictions and/or recommendations.

At step 304, one or more computing devices (such as the application server 107) may periodically or continuously collect data that may be useful for predicting content popularity. The data may include, for example, raw ratings information, social network information, information about actions taken by viewers, such as channel changes, recordings, volume changes, trick play functions, and/or the like. The data may additionally or alternatively include any of the above-mentioned scores, such as content scores, channel scores, social activity scores, and/or DVR scores. Where the raw data is collected, the scores may be calculated during step 304. The collected data may be stored in a datastore, which may include one or more computer-readable storage media such as hard drives, tape drives, optical discs, memory chips, and/or the like. The data store may be located anywhere, such as at the local office 103 (e.g., as part of the application server 107) or as part of the external network 109.

At step 305, a software model that may reside at the one or more computing devices (such as at the application server 107) may be trained using the data collected at step 304, and/or using data previously collected.

At step 306, the model may be applied to make predictions as needed, which will be described below with regard to step 303. This process may again (e.g., periodically or continuously) return to step 304 for further data collection and/or training. It is noted that steps 304-306 may or may not be performed in the order shown. In fact, any of the steps 304-306 may be performed in parallel with one another as desired. For example, data collection at step 301 and/or model training at step 302 may occur while the model is being applied at step 306.

Possibly in parallel with data collection and/or model training, at step 301, the one or more computing devices (such as the application server 107) may periodically or continuously determine which items of content are available, for example, scheduled to be distributed, within a future time frame, or available for access from one or more various storage locations and/or networks. The future time frame may be a fixed time frame that may or may not include the present time. For example, the future time frame may begin at the present time and extend a fixed amount of time in the future, such as seventy-two hours in the future. For example, starting with a program schedule for the upcoming seventy-two hours, the one or more computing devices may identify those items of content for each of a plurality of channels that are scheduled to play during each thirty-minute (or other) interval. Or, for example, the future time frame may begin at a first point of time in the future and end at a second point of time in the future. For instance, the future time frame may begin twelve hours in the future and extend to seventy-two hours in the future. However, the future time frame need not be a fixed amount of time, and may dynamically change if desired. At step 301, the one or more computing devices may generate data indicating a set of items of content that are scheduled to begin and/or scheduled to be distributed during the future time frame. The determination of step 301 may be for a single channel or other service, or for a plurality of channels or other services.

At step 302, the data generated at step 301 may be used to determine which previously-collected data is relevant to a determination of popularity of the indicated items of content. Such a determination may involve, for example, searching for portions of the collected data (e.g. ratings, such as user or third party ratings, e.g., Nielsen channel and/or content ratings; the number of scheduled recordings of the identified available (e.g., upcoming) programs; and/or social activity information) that correspond to the upcoming programs that were determined at step 301. For instance, if a particular episode of a program series is scheduled to be distributed within the future time frame, then step 302 may involve searching the previously-collected data for data indicating ratings and/or other information for earlier distributions of any episodes of the content series. The data determined at step 302 may be limited to a past time frame, such as data for content for which there were showings or other uses of the content within the past six months, within the past three months, or within the past year. This may be desirable because more recent ratings information may be more relevant to upcoming programs. However, the data determined at step 302 need not be limited to a particular past time frame, if so desired.

At steps 303 and 306, the one or more computing devices (e.g., the application server 107) may apply the model to the data that was determined at step 302 to predict the popularity of some or all of the upcoming items of content that were identified at step 301. Applying the model may result in data representing the determined popularity for some or all of the upcoming items of content, such as in the form of a predicted popularity score. For example, the predicted popularity scores may be numeric, such that a higher predicted popularity score may indicate a higher predicted popularity, and a lower predicted popularity score may indicate a relatively lower predicted popularity. However, the predicted popularity scores may be arranged, formatted, and interpreted in any manner desired.

At step 307, the one or more computing devices (e.g., the application server 107) may use the results of applying the model (e.g., the predicted popularity scores) to rank the upcoming items of content in order of predicted popularity score. Then, the list of upcoming items of content may be divided into those upcoming items of content with the highest predicted popularity scores may be considered popular upcoming items of content and those with lower predicted popularity scores. The division may be made at a threshold, such as between the top X % and lower (100−X) % in popularity scores, where X may be any percentage, for example between 80% and 90%, or between 70% and 90%, or between 50% and 95%. In another example, the division may be made at a threshold number of popular upcoming items of content, such as the top Y number of upcoming items of content that are predicted to be the most popular, where Y may be, for example, ten, or between five and twenty, or between five and fifty. The remaining upcoming items of content may or may not be discarded as candidates for popular upcoming items of content, as desired.

At step 308, the result of the ranking and/or dividing may be reported by the one or more computing devices, such as to the viewers. For example, data indicating the determined most popular upcoming programs may be sent by the local office 103 over communication links 101 to any of the devices 110-117 for presentation to viewers. The data sent to the devices 110-117 may represent only those items of content considered to be most popular (e.g., only the top X % or top Y number of the upcoming popular items of content), or the data may represent all of the upcoming items of content for which popularity scores have been determined. The data may further include an indication of the relative ranking of the popular upcoming items of content (e.g., explicitly with ranking numbers or popularity scores, and/or implicitly by virtue of the order in which the upcoming items of content are presented in the data). Examples of how the popular upcoming items of content may be presented to viewers will be described below.

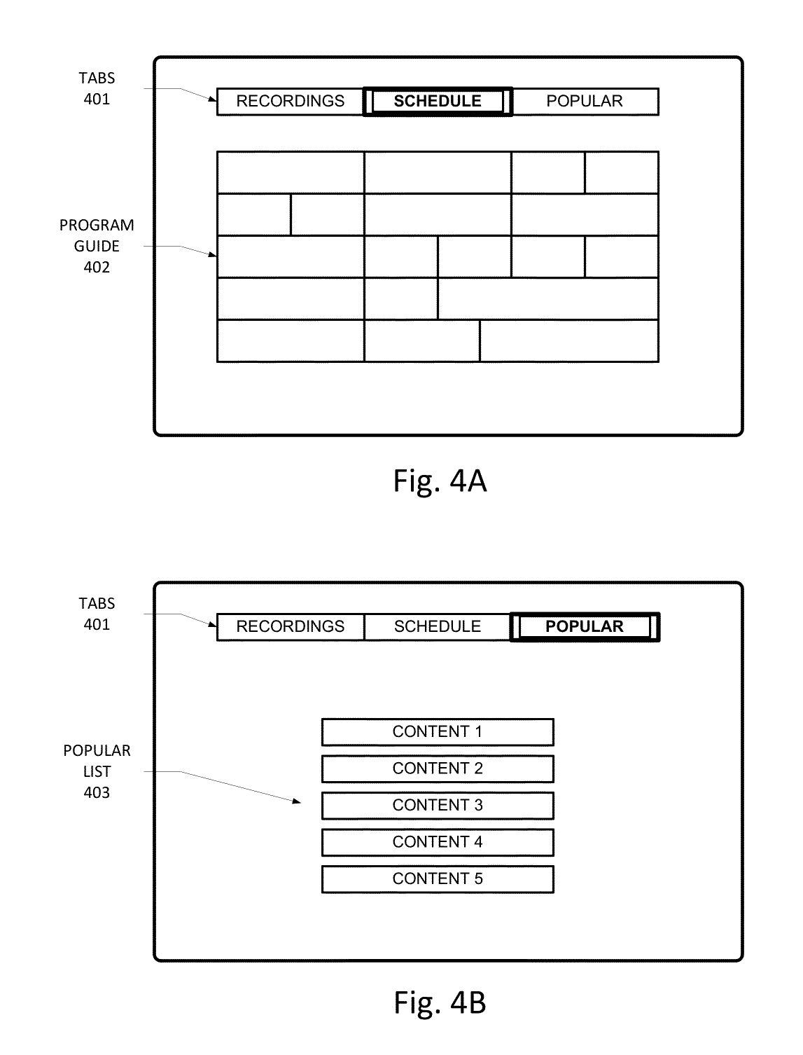

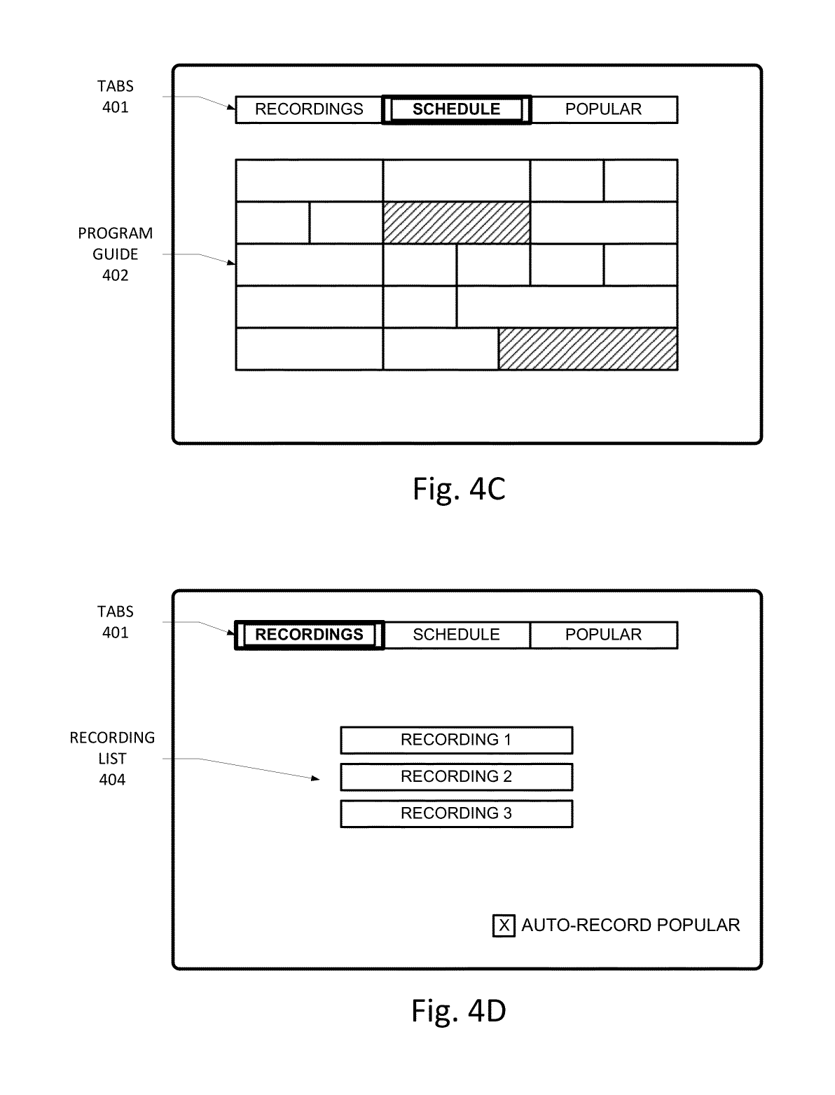

FIG. 4A shows an example user interface that may be displayed, for example, by a display device that is part of and/or coupled to, e.g., any of the devices 110-117 of FIG. 1. Data used to generate the user interface may be stored locally by the devices 110-117 and/or may be received from another source, such as from the local office 103 via the communication links 101. The user interface of FIG. 4A shows a plurality of user-selectable tabs 401, which in this example include tabs for recordings, schedule, and popular. In FIG. 4A, the schedule tab is currently selected, as indicated by the highlighting of that tab. As a result of the schedule tab being selected, the user interface may display a program guide 402, which in this example is presented as a grid-format guide (time axis versus channel axis, if channels are used), in which each box within the program guide 402 represents a different scheduled program, on-demand program, and/or other service. However, the program guide 402 may be presented in any format desired, such as a linear listing. The program guide 402 may indicate, for example, past, present, and/or future items of content that have been, are, and/or will be scheduled for distribution, and/or items of content that may be provided as on-demand items (e.g., VOD items of content) that may be presented in response to a user request. When a user selects one of the items of content in the program guide 402, the user interface may present the user with information about the selected item of content and/or provide options to record and/or tune to the selected item of content. In some examples, selection of a currently-shown (e.g., currently streamed, currently broadcast, currently unicast, currently multicast, and/or otherwise currently distributed) items of content may cause the user device to immediately tune to the item of content, and selection of a future-scheduled item of content may cause the user device to schedule a recording of that item of content. While the tabs 401 and the program guide 402 are shown in a particular way in FIG. 4A, the user interface may be arranged in other ways, with or without the tabs 401.

FIG. 4B shows an example of how the user interface may be presented upon the popular tab being selected. In this example, the program guide 402 is replaced with a popular list 403 or other indication of at least some of the popular upcoming items of content that were reported at step 308. The list 403 may list the popular upcoming items of content in order of popularity. For example, the top of the list (Content 1) may have the highest predicted popularity, followed by Content 2 having the next highest predicted popularity, and so on. The list 403 may or may not be filtered in accordance with the viewer's personal preferences. For example, if a preference profile of the viewer (which may be stored locally at the viewer's device and/or on the network side such as at the local office 103) indicates that the viewer is interested in items of content having a first characteristic but not a second characteristic, then the list 403 may exclude those of the popular upcoming items of content that have the second characteristic and include those of the popular upcoming items of content that have the first characteristic. Or, the list 403 may de-rank (e.g., lower the ranking) of those of the popular upcoming items of content having the second characteristic and or increase the ranking of those of the popular upcoming items of content having the first characteristic, thereby placing those upcoming popular items of content that are likely to be of more interest to the viewer higher on the list 403. The viewer's preference profile may include information such as preferred and/or excluded content characteristics (e.g., documentary, comedy, drama, movie, horror, particular content names and/or content series, particular actors, particular directors, particular MPAA ratings, particular channels, and/or the like). Thus, in general, the list 403 may present a subset of the popular upcoming items of content and/or present the popular upcoming items of content in an order that may at least partially depend upon the viewer's preference profile.

The user may select any of the popular upcoming items of content in the list 403, and as a result, the user may be presented with further information about the selected item(s) of content and/or be provided with the option to set a recording for the selected item(s) of content if not already set to record. Where there exists more upcoming popular items of content than can be fit on a single user interface screen at once, the list 403 may be scrollable and/or otherwise navigable to show others of the popular upcoming items of content. Moreover, the popular upcoming items of content need not be presented as a single linear list, but may be presented in any manner desired, such as being arranged in selectable categories (e.g., upcoming popular movies, upcoming popular comedies, etc.), as a two-dimensional grid of channels versus time, and/or in any other manner. Moreover, the list 403 may be filterable and/or searchable by viewers by keyword and/or according to one or more criteria, such as by genre, director, actors, title, length, content type, scheduled time, etc.

An example of a two-dimension grid of channels versus time in which the upcoming popular items of content may be presented is shown in FIG. 4C. In this example, the program guide 402 may be supplemented with indications of the popular upcoming items of content. For example, as shown in FIG. 4C, those boxes of the program guide 402 corresponding to popular upcoming items of content may appear differently from other items of content, such as by shading (as indicated in FIG. 4C), differing color, differing font, highlighting, animation, graphics, symbols, and/or the like, that may distinguish the popular upcoming items of content from the other upcoming items of content. In yet another example, the popular upcoming items of content may be presented together as a virtual/logical channel of the program guide 402. The items of content indicated in FIG. 4C as popular upcoming items of content may be filtered in the same manner as described above with reference to FIG. 4B, if desired.

FIG. 4D shows an example of how the user interface may be presented upon selection of the recordings tab. In this example, the user interface may include a recording list 404 of any items of content that are scheduled to be recorded at a future time and/or of items of content that have already been recorded. The list 404 is merely one example of how such information may be presented. The user interface may also include a user-selectable checkbox or other user interface element that may allow the user to request the device and/or the network to automatically record popular upcoming items of content, such as any of the popular upcoming items of content included in the list 403 and/or that were reported at step 308. The auto-record feature implemented by the viewer's device and/or by a network DVR may apply to all of the popular upcoming items of content, or it may apply to (e.g., record) only at subset of the popular upcoming items of content in accordance with the viewer's preference profile. For example, popular upcoming items of content that have a characteristic excluded by the viewer's preference profile may not be automatically recorded. The viewer may further be presented with advanced options for how recordings are to be made (e.g., every episode, only new episodes, etc.) and/or how long the automated recordings of items of content are to be kept before being discarded (e.g., erased or overwritten).

An example of how the model for predicting content popularity may be configured will now be described. As previously discussed, various information about past items of content may be used to predict the popularity of future (e.g., scheduled) items of content. The information may include, for example, ratings information (such as, but not limited to, Nielson ratings information, channel scores, and/or program scores), information about viewer behavior (e.g., which programs were previously recorded by viewers, which programs were tuned to and/or tuned away from by viewers, and/or the DVR scores), information about social activity (e.g., Twitter messages, Facebook posts about the programs, Facebook likes, and/or the social activity scores). This information (e.g., the various scores) may be combined to determine an overall popularity score for each identified item of content or series thereof. The information may be combined using a ranking function. However, combining the information into a consistent ranking function may not be straightforward, because not every score or other item of information may be necessarily available for each item of content, and because scores may differ in how much they change over time or correspond to different types of viewer behavior. For example, the coverage of television program ratings by Nielsen has generally been only about a third of the programs that are scheduled for a given twenty-four hour period, while Nielsen national channel ratings have generally been available for about 120 channels that cover 90% of the programs that are typically being watched. On the other hand, the distribution of DVR scheduled recordings may be much more peaked than the distribution of Nielsen ratings across programs. This is likely due to the fact that the typical viewer schedules only a handful of programs for recording, while not being as selective while browsing through current programs.

By way of example, the model (which may be at least partially implemented as computer-executable instructions executed by one or more computing devices) may use future ratings as one or more target variables to compute a range of statistics for each input. The statistics may be used as a feature in a regression and/or classification framework to approximate the target variable. A predicting component of the model may then input into a temporal filtering framework to compute the ranking function that may be used to sort the items of content by predicted popularity. For instance, the model may operate as follows: For each upcoming (current and/or future) item of content and time interval/date (e.g., for each thirty-minute time interval), do the following:
1. Statistics Extraction: for each input score, e.g., ratings data source (e.g., Nielsen), DVR, Facebook likes, Twitter activity, etc.:
   a. Obtain historical content scores for the seven (or another predetermined number) last showings or other uses of the item of content; if content scores for less than the seven (or the other predetermined number) prior showings or other uses can be found, use historical channel scores instead for the channel on which the item of content is presented.
   b. Obtain historical social activity scores and historical DVR scores for the item of content.
   c. Compute statistics for each of the obtained sets of scores, such as: maximum value, minimum value, mean, median, most recent value, mean of the last three (or another predetermined number) values, and/or median of the last three (or another predetermined number) values.
2. Model Estimation (during training phase): Train a regression and/or classification function for past showings or other uses of the item of content for which historical data exists, using, for example, historical program scores and/or historical channel scores as target variables.
3. Prediction: Based on the trained model, predict the popularity of the item of content.
4. Ranking. Sort the items of content by the predicted popularity.

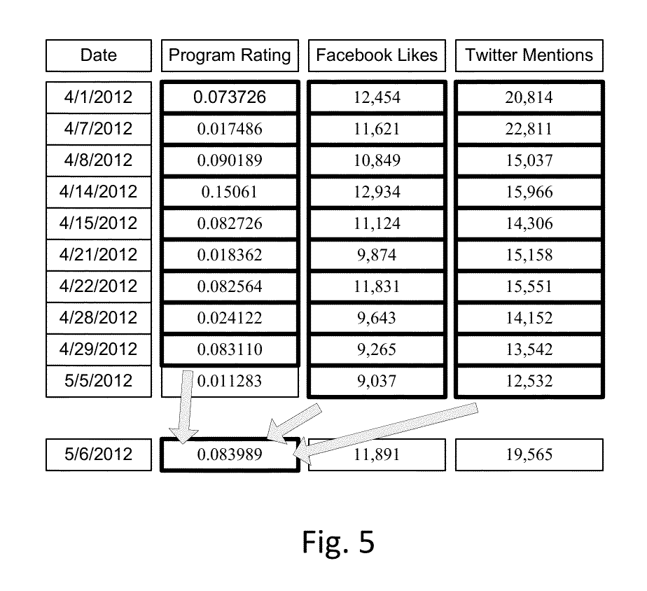

The model may be configured to learn the ranking function ƒ, such that ƒ(x)>ƒ(y) when program x is supposed to be ranked higher than program y. The function ƒ may be determined and/or optimized in a variety of ways. For example, the ranking problem may be modeled as a pairwise classification problem, e.g., to find a classification function that returns a positive value if x should be ranked higher than y, and returns a negative value otherwise. Another possibility is to use regression functions to model the ranking ƒ directly. For the classification approach, support vector machines, k-nearest neighbor approaches, and/or random forest classifier techniques may be used, for example. For the regression approach, linear models with L1 (absolute value) and/or L2 (least squares) regularization terms, k-nearest neighbor regression, support vector regression, decision trees, and/or random forest regression techniques may be used, for example. In another example, shallow random forest regression trees may be used with historical content and/or channel scores scores and/or current and/or historical social activity scores as feature inputs such as those shown in the table of FIG. 5. In the example of FIG. 5, historical information has been collected that is related to previous showings of a particular program (or of episodes of a particular series of content). In particular, the example information includes dates (and possibly also times) of the showings, ratings information for each of the showings, and social activity information such as Facebook likes for each of the showings (and/or for the series of episodes) and Twitter mentions of the showings and/or series. The values bounded by a thicker line in FIG. 5 represent those of the historical values that might be used to predict its future rating. In this example, past ratings information and both past and current social activity information associated with the item of content or series thereof may be used to predict the future rating of the item of content or series thereof. Thus, for instance, assuming that data has been collected from Apr. 1, 2012 through the current day (which will be assumed by way of example as being May 5, 2012), then in this example the ratings information for the item of content or series from Apr. 1, 2012 through Apr. 29, 2012 may be used by the model, along with the social activity information for the program or series from Apr. 1, 2012 to May 5, 2012, to predict the ratings information for an available item of content, such as a future scheduled showing of the item of content or series on May 6, 2012.

When the actual rating information and/or social activity information for May 6, 2012 (in this example) is later collected, this information may be used to re-calibrate the model (e.g., by re-calibrating the ranking function ƒ). To evaluate the effectiveness of the ranking function ƒ, and to determine whether re-calibration is appropriate, it may be determined how many of the actual top k (where k is a predetermined whole number) ranked items of content according to the actual historical collected ranking data can be found among the top k items of content predicted by the model. The value k may be of any value, such as but not limited to any value from 5 to 50. It is noted that, while Facebook likes and Twitter mentions are indicated in FIG. 5, these are merely examples. Social web site and/or other group media from any other sources and of any other types may be used as input data for making popularity predictions. Also, while the numbers shown in FIG. 5 may be of a particular scale, the numbers may be on any other scale and may include information other than purely numerical information, such as but not limited to alphabetical information and/or true-versus-false indications.

Thus, an approach has been presented that combines information about past showings or other use of items of content, such as but not limited to ratings information (e.g., Nielsen ratings), DVR schedule information, and social networking activity measurements, in a temporal filtering framework to predict the popularity of available items of content, such as future showings of items of content. The framework described herein may be extended in a number of ways. For example, one could design more complex models to predict the popularity of an item of content that incorporate both content attributes and other measures of popularity. Examples of content attributes may include an indication of whether an item of content is a new item of content (e.g., a new episode in a series), an indication of whether an episode is the season premiere, which genre(s) an item of content is associated with, the actors and/or directors in the item of content, etc. Other measures of popularity that may be used as inputs to the model (and that may be collected as ratings-relevant information) may include, for example, box office numbers for movies, Rotten Tomatoes web site reviews, and the presence or absence of published editorial recommendations. Moreover, the aggregate popularity prediction may be combined with personalized recommendation algorithms that take a viewer's content consumption history into account to potentially deliver truly personalized content recommendations to viewers.

Examples have been described in which the prediction model may be applied to future (e.g., scheduled) items of content, before those items of content are shown. However, the prediction model may also be applied to items of content that are currently being shown. For example, the popularity of a future item of content may be predicted using the model prior to the scheduled showing of the item of content, and this predicted popularity may be reported to viewers such as in the manner described above. As the scheduled time for the item of content to begin approaches, the model may again be applied as many times as desired to update the predicted popularity. Moreover, once the item of content has begun being shown at the scheduled time, the model may continue to be applied to continue to ascertain the popularity of the item of content. While some types of input data may not be immediately available during the showing of the item of content (e.g., Nielsen ratings), other types of input data may, such as viewer behavior. For instance, if, during the showing of the item of content, a certain number of viewers tune to the item of content (which may have been influenced by the previous predicted popularity of the item of content reported to viewers), the model may again be used to update the popularity of the item of content with the actual number of viewers currently tuned to the item of content and/or the duration in which each of the viewers is tuned to the item of content.

Also, while the reporting of results at step 308 has been described as being useful to assist viewers in selecting items of content that may be of interest to them, the results of the prediction model may additionally or alternatively be used for other purposes. For example, the predicted popularity of an item of content may be correlated with the impact of an advertisement played in conjunction with the content and/or with click through rates for on-line programming). Therefore, predicted popularity of an item of content may be correlated with past correlations between popularity and advertising impact to predict upcoming advertising impact rates. This may also be useful in determining an appropriate amount to be charged by the content distributor for an advertisement time slot. Moreover, since the popularity of an item of content may be predicted on a near real-time basis, a content distributor may dynamically adjust the advertising rate for an advertisement time slot, even during the showing of the item of content that is associated with the advertisement time slot. Alerts may also be provided to viewers in real time or near-real time, indicating (such as via a user interface at a viewer's device) that there is strong social activity (e.g., many Facebook “likes” and/or Twitter mentions) related to a particular item of content. In addition, items of content predicted to be popular (e.g., meeting at least a minimum predicted popularity rating value) may be automatically recorded by a viewer's DVR. Moreover, predicted popularity of items of content may be used as a signal for personalized recommendations of content to viewers. For example, predicted popularity may be used in lieu of, or in conjunction with, actual usage data as a signal for computing personalized recommendations.

Although example embodiments are described above, the various features and steps may be combined, divided, omitted, rearranged, revised and/or augmented in any desired manner, depending on the specific outcome and/or application. Various alterations, modifications, and improvements will readily occur to those skilled in art. Such alterations, modifications, and improvements as are made obvious by this disclosure are intended to be part of this description though not expressly stated herein, and are intended to be within the spirit and scope of the disclosure. Accordingly, the foregoing description is by way of example only, and not limiting. This patent is limited only as defined in the following claims and equivalents thereto.

What is claimed is:

1. A method, comprising:
using, by one or more computing devices, data associated with past use of items of content to predict a ranking of a future item of content; and
sending, over a network, data based on the ranking of the future item of content to a device.

2. The method of claim 1, further comprising:
training a model based on historical ratings data,
wherein said using comprises using the model and the data representing associated with past use of items of content to predict the ranking of the future item of content.

3. The method of claim 1, wherein the data associated with past use of items of content comprises data representing popularity ratings of past showings of items of content.

4. The method of claim 1, wherein the data associated with past use of items of content comprises data representing social network activity.

5. The method of claim 1, wherein the data associated with past use of items of content comprises data representing DVR commands made during the past use of items of content.

6. The method of claim 1, wherein said using further comprises also using data representing scheduled recordings of a plurality of future items of content to predict the ranking of the future item of content.

7. The method of claim 1, wherein the data associated with past use of items of content comprises data representing channel tuning behavior during the past use of items of content.

8. The method of claim 1, further comprising:
determining a future time period; and
determining the future item of content based on the future time period.

9. The method of claim 1, further comprising generating a user interface, the user interface comprising:
an indication of the ranking of the future item of content, and
a schedule of a plurality of future items of content including said future item of content.

10. The method of claim 1, further comprising determining an advertising rate for a timeslot during the future item of content based on the ranking of the future item of content.

11. A method, comprising:
determining a plurality of future items of content scheduled to be shown during a future time period;
using, by one or more computing devices, data representing popularity of past use of items of content to predict popularity of each of the plurality of future items of content; and
sending, over a network, data representing the popularity of at least one of the plurality of future items of content to a device.

12. The method of claim 11, wherein said using further comprises also using data representing social network activity to predict the popularity of at least some of the plurality of future items of content.

13. The method of claim 11, wherein said using further comprises also using data representing DVR commands made during the past use of items of content to predict the popularity of at least some of the plurality of future items of content.

14. The method of claim 11, wherein said using further comprises also using data representing scheduled recordings to predict the popularity of at least some of the plurality of future items of content.

15. The method of claim 11, wherein said using further comprises also using data representing channel tuning behavior during the past use of items of content to predict the popularity of at least some of the plurality of future items of content.

16. The method of claim 11, further comprising determining an advertising rate for a timeslot during the at least one of the plurality of future items of content based on the popularity of the at least one of the plurality of future items of content.

17. A method, comprising:
using, by one or more computing devices, data representing popularity of past use of items of content to predict popularity of each of a plurality of future items of content; and
generating a user interface comprising an indication of the popularity of at least one of the plurality of future items of content.

18. The method of claim 17, wherein said generating further comprises generating the user interface to also indicate a schedule of at least some of the future items of content.

19. The method of claim 17, wherein said using further comprises also using data representing social network activity to predict the popularity of at least some of the plurality of future items of content.

20. The method of claim 17, wherein said using further comprises also using data representing scheduled recordings to predict the popularity of at least some of the plurality of future items of content.
